(19) United States
(12) Patent Application Publication
(10) Pub. No.: US 2004/0030583 A1
(43) Pub. Date: Feb. 12, 2004

(54) Clinician-laboratory electronic communication system

(76) Inventor: Matthew G. Fleming, Milwaukee, WI (US)

Correspondence Address: QUARLES & BRADY LLP, 411 E. WISCONSIN AVENUE, SUITE 2040, MILWAUKEE, WI, 53202-4497, US

(21) Appl. No.: 10/215,161

(22) Filed: Aug. 8, 2002

(51) Int. Cl. G06F 17/60

(52) U.S. Cl. 705/3

(57) ABSTRACT

An electronic communication system for transmitting laboratory submission slips and report data between a clinical setting and a laboratory is disclosed. Submission slip information including textual data and multimedia images and audio information are transmitted directly to a laboratory computer. As evaluation of a sample progresses, the clinician obtains progress data, and, ultimately, a final report directly from the laboratory computer.

### CROSS-REFERENCE TO RELATED APPLICATION

Not applicable.

### STATEMENT REGARDING FEDERALLY SPONSORED RESEARCH OR DEVELOPMENT

Not applicable.

### BACKGROUND OF THE INVENTION

The present invention is a system for improving communication between a clinical laboratory and the clients of that laboratory and more particularly a system for electronically providing pathology slips to a laboratory.

Physicians and other medical or clinical personnel rely heavily on laboratories for testing and analyzing biological samples such as tissue, blood, and urine. Typically, the physician collects a biological sample from a patient and fills out a laboratory submission slip to accompany the specimen. The submission slip includes data such as the name of the physician, the name of the patient, the type of sample taken, the number and type of tests to be performed and other information that the laboratory requires. These slips are typically handwritten by the physician. The physican maintains records of a submission either by maintaining a paper copy of the slip, or entering the data into a local computer.

After the pathology slip is completed, the sample and pathology slip are forwarded to the laboratory using mail or messenger services. After the laboratory receives the sample and pathology slip, the appropriate tests are performed and a written, text-based report is prepared. This report is forwarded to the physician, again typically through a mail or messenger service.

While present methods of communication between physicians and laboratories are generally adequate, there are a number of problems associated with these methods. First, as noted above, laboratory slips and associated laboratory reports are typically text-based. Text-based descriptions are time consuming to prepare and, in increasingly busy clincial settings, often are not completed with sufficiently detailed information to capture all of the clinical data needed by the laboratory personnel. Such problems are particularly acute in communications between a dermatologist and a dermatopathologist, since in dermatopathology, a significant amount of clinical information is required for proper analysis of a specimen. Also, skin biopsies and other diagnostic procedures are increasingly performed by general practitioners, rather than specialists, and these practitioners may lack the training to provide a detailed and accurate clinical description to include with the submitted specimen.

Second, it is difficult to concisely and accurately record the site of a procedure using textual records alone. This is important, for example, in the treatment of skin cancers, of which many millions occur in the United States each year. Skin cancers are not treated with a single procedure but rather, an initial biopsy is performed, followed by a second, therapeutic procedure after analysis of the biopsy specimen has confirmed the diagnosis of cancer. A common problem is inability to locate the site of the initial biopsy when the patient returns for the second procedure.

Furthermore, with present methods laboratory submission slips are almost always handwritten, and can be difficult to decipher at the laboratory, prompting phone communications between laboratory and clinicians which are a waste of time for both parties. The data from the slips are keyed into a computer system at the laboratory and often rekeyed at the clinic, which is a duplication of effort and potential source of error.

Additionally, because communications between the laboratory and the physician are typically provided through mail or messenger services, communications are slow. Once a physician submits a laboratory slip and specimen, there is typically no communication from the laboratory until the final report is issued by the laboratory and received by the clinician. The clinician is not informed when the specimen is received by the laboratory, does not receive the results of interim examinations of the specimen, is not routinely informed if a specimen has been delayed, etc. As the information is not available to the clinician, the clinic cannot appropriately track the progress of the analysis, or plan and schedule repeat visits, additional testing, or surgical procedures.

There remains a need, therefore, for a method for quickly and efficiently communicating medical data between a clinical setting and a laboratory.

### SUMMARY OF THE INVENTION

The present invention is a method for communicating laboratory test data between a laboratory and a clinic. Patient data, which can include a multimedia description of a medical condition, is recorded in an electronic laboratory submission slip on a clinical computing device. The electronic submission slip is selectively transmitted to a laboratory computer where it is retrievable and modifiable by laboratory personnel. Periodically, data is synchronized between the laboratory computer and the clinical computer to provide updated status data for advising the clinician of the status of laboratory analysis.

A general object of the invention is to provide a clinical computing device including a processing unit, a display, and a communications device for transmitting data to and receiving data from a laboratory computer. The clinical computing device is programmed to store an electronic submission slip including textual and multimedia clinical data in a memory component, transmit the electronic submission slip to the laboratory computer through the communications device, receive test status and analysis data from the laboratory computer through the communications device, and provide text and multimedia data associated with the submission slip data and the test status data on the display for review by the clinician. Local data, including notes and reminders, can be stored in the memory of the clinical computing device and be associated with the submission slips and laboratory test data for use by a clinician.

Another object of the invention is to provide a method for communicating data between a clinician and a laboratory. Patient data including at least one of a textual and a multimedia medical description is stored in an electronic submission slip in a clinical computing device, and identified by a case identification number. The submission slip is selectively transmitted to a laboratory computer, and is submitted in conjunction with a clinical specimen, also identified by the case identification number. The submission slip is retrieved from the laboratory computer, and the case identification number of the specimen is correlated with the submission slip. The specimen is analyzed and the results are stored in a laboratory report in the laboratory computer which is selectively transmitted to the clinical computing device.

These and other aspects of the invention will become apparent from the following description. In the description, reference is made to the accompanying drawings which form a part hereof, and in which there is shown a preferred embodiment of the invention. Such embodiment does not necessarily represent the full scope of the invention and reference is made therefore, to the claims herein for interpreting the scope of the invention.

### BRIEF DESCRIPTION OF THE DRAWINGS

FIG. 1 is a block diagram of a clinician communications system constructed in accordance with the present inventor.

FIG. 2 is a block diagram of the clinical computing device of FIG. 1;

FIG. 3A is a perspective view of the display of the clinical computing device of FIG. 2, illustrating a file menu of the main menu screen;

FIG. 3B is a perspective view of the display of the clinical computing device of FIG. 2, illustrating an edit menu of the main menu screen;

FIG. 3C is a perspective view of the display of the clinical computing device of FIG. 2, illustrating a view menu of the main menu screen;

FIG. 3D is a perspective view of the display of the clinical computing device of FIG. 2, illustrating an options menu of the main menu screen.

FIG. 4 is a perspective view of the display of the clinical computing device of FIG. 2 illustrating a first part of an electronic submission slip data entry screens;

FIG. 4B is a perspective view of the display of the clinical computing device of FIG. 2 illustrating a first part of an electronic submission slip data entry screens second page.

FIG. 5A is a perspective view of the display of the clinical computing device of FIG. 2 illustrating the attach photo function;

FIG. 5B is a perspective view of the display of the clinical computing device of FIG. 2 illustrating a dialog server for attaching photos.

FIG. 6 is a flow chart illustrating synchronization steps at the clinical computing device of FIG. 2;

FIG. 7 is a flow chart illustrating the synchronization process at the laboratory computer of FIG. 1;

FIG. 8 is a flow chart illustrating the process for downloading a submission slip from the device of FIG. 2 to the laboratory computer of FIG. 1;

FIG. 9 is a flow chart illustrating the synchronization process for updating submission slips at the clinical computing device;

FIG. 10 is a flow chart illustrating the process for downloading reports to the clinical computing device of FIG. 2; and

FIG. 11A is a perspective view of the display of the device of FIG. 2 illustrating an edit name for a report dialog for servicing and organizing laboratory reports;

FIG. 11B is a perspective view of the display of the device of FIG. 2 illustrating an edit name for a report dialog for servicing and organizing laboratory reports view menu.

### DETAILED DESCRIPTION OF THE PREFERRED EMBODIMENT

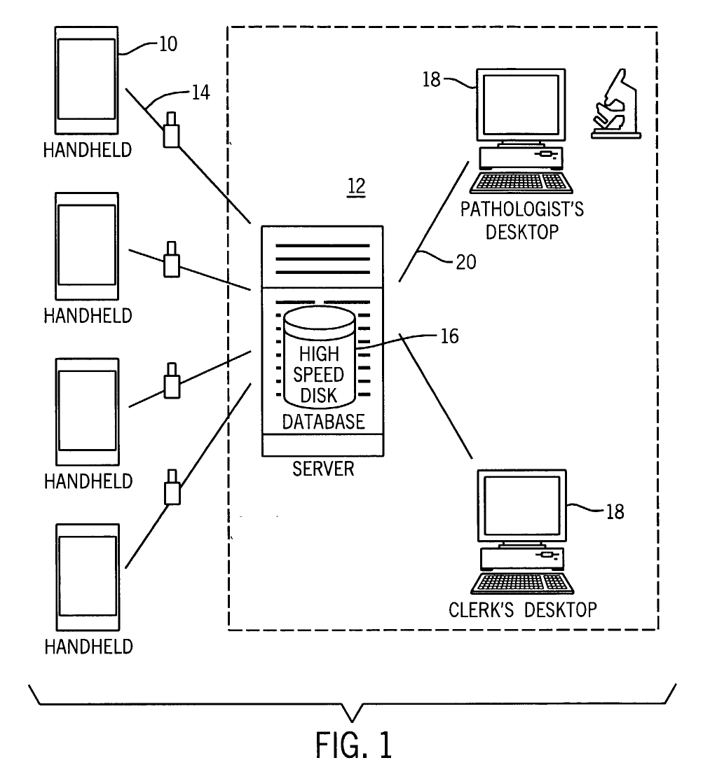

Referring now to the Figures, and more particularly to FIG. 1, a block diagram of an electronic communications system constructed in accordance with the present invention is shown. The communications system generally comprises one or more clinical computing devices 10 which are linked to a central laboratory computer 12, typically a server, via a bi-directional communication link 14. Clinical personnel, typically physicians, enter patient data into the clinical computing device 10 to produce an electronic laboratory submission slip. These data can include, for example, identifying data such as patient name, date of birth, and date of examination, as well as a description of a condition. The description of the condition can include both textual data and multimedia data including graphic, photographic, or video images of a region of interest on the patient, and audio notes recorded by clinical personnel. The submission slip is transmitted from the clinical computing device 10 to the central laboratory computer 12 via the bi-directional communication link 14. In conjunction with the electronic submission slip, the clinical personnel forward a sample of the patient's condition (a specimen) to the laboratory for analysis.

At the central laboratory computer 12, data uploaded from the clinical computing device 10 are stored in a database 16, where they can be augmented with additional information entered by laboratory personnel. Laboratory personnel preferably access the central laboratory computer 12 through a networked client computer 18 linked to the laboratory computer 12 through a second bi-directional communications link 20 such as an intranet link. The data maintained on the clinical computing device 10 and on the central laboratory computer 12 are periodically synchronized through the bi-directional communications link 14 so that both systems contain current, complete information, as described more fully below. Prior to transmission, the data are moved from a structured format to a packed, serialized format. As necessary, the transmitted data can also be converted from a first to a second character set as, for example, when the laboratory computer 12 uses ASCII and the clinical computing device 10 uses the Unicode character set.

As and after the sample is processed at the laboratory, laboratory personnel evaluate and interpret the sample. Using the central computer 12, laboratory personnel can examine the contents of the electronic submission slip, including any attached multimedia data, as an aid in formulating their interpretations of the sample. Laboratory personnel record the results of their evaluation of the sample in a report which is stored on the central computer 12, and then downloaded to the clinical computing device 10. Any multimedia data which had been attached to the submission slip remain attached to the final report, and can be examined by clinical personnel, as described below.

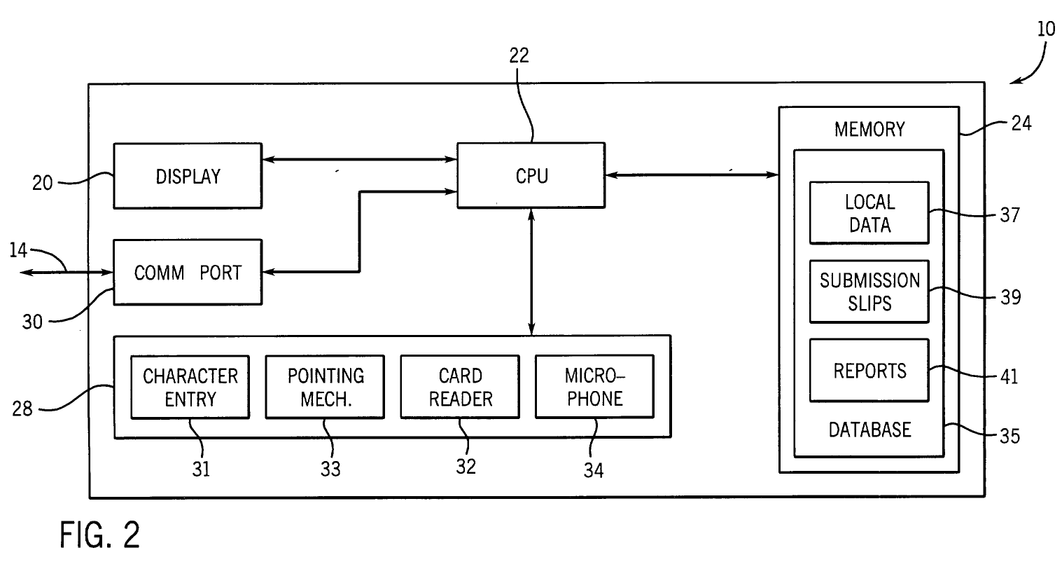

Referring now to FIG. 2, the clinical computing device 10 is preferably a small portable computer such as a personal digital assistant (PDA) but can be any of a number of devices which include a processing unit or CPU 22, memory 24, display 26, data entry device 28, and a communications port or bi-directional communication device 30. The display 20 is preferably a touchscreen. The data entry device 28 includes a character entry system 31 and further includes a pointing mechanism 33 such as stylus or a mouse. For attaching multimedia data, the clinical computing device 10 also includes a memory card reader 32, such as a Compact Flash reader (to access images from a digital camera or other image recording device) and a microphone 34 for recording audio notes. The communications device 30 is preferably a hardware device providing TCP/IP network access, but could also comprise an interface to a cellular telephone network, wide area network, local area network, satellite link, or other type of wired or wireless communication system. Although the clinical computing device 10 is preferably a handheld computer such as a Pocket PC or PDA, a laptop computer, tablet PC, desktop computer, terminal, or cellphone handset can also be used.

The clinical computing device 10 runs software which communicates with the central laboratory computer 12 to send and receive textual and multimedia data. These data comprise both laboratory submission slips 39 and laboratory reports 41 which are stored in a database 35, preferably a SQL database in the memory component 24 of the clinical computing device 10. The submission slips 39 and laboratory reports 41 are each stored in conjunction with a synchronization status category used in synchronizing data between the clinical computing device 10 and laboratory computer 12, as described below. The database 35 also stores local data 37, such as reminders and notes for the clinician, which are not communicated with the central laboratory computer 12.

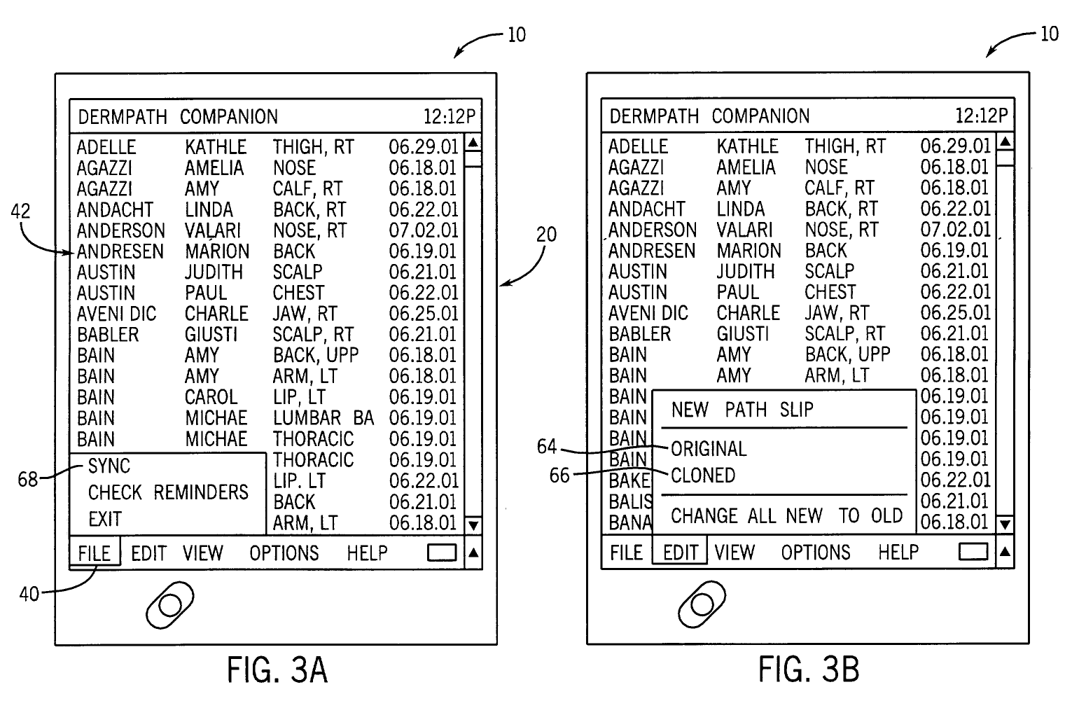

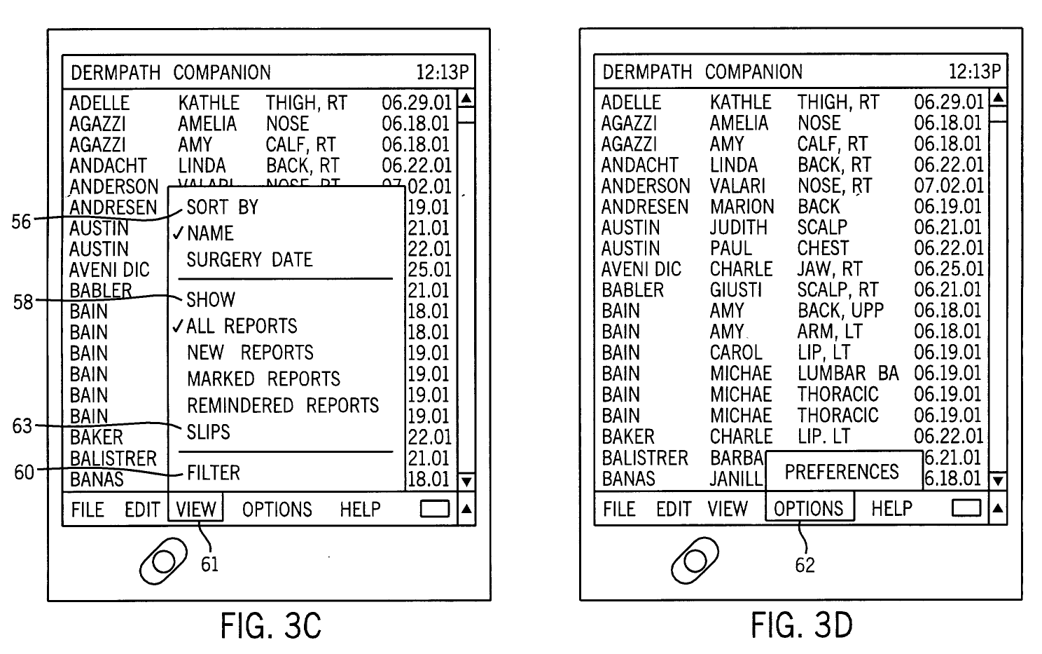

Referring now to FIGS. 3A-D, the main menu screen of the clinical computing device 10 is shown. Referring first to FIG. 3B, to enter laboratory submission slip data into the computing device 10, the user initially activates the device 10 and selects the function “Edit|(New Path Slip) Original” 64 from the menu 40, or alternatively single-clicks on a report to select it from a displayed report list 42, and then selects “Edit|(New Path Slip) Cloned” 66 from the menu 40. The Edit|(New Path Slip) Original 64 is selected for a new patient, whereas the cloning function, which copies fields from an existing report to a new submission slip, is typically used for an existing patient.

Referring now also to 4, which illustrates the submission slip on the display 20 of the clinical computing device 10, after a new or cloned submission slip is selected the clinical computing device 10 assigns a case identification (CaseID) number to the slip. The CaseID field 70 contains an alphanumeric string comprising a three digit client identifier (ClientID), a two digit year identifier, and a specimen number. The ClientID is a designator which is issued by the laboratory and entered onto the clinical computing device 10 under the “Options|Preferences” (62, FIG. 3D) menu selection, described below, and which is unique to each clinical computing device 10. The second part of the CaseID string is the last two digits of the year. The specimen number is a number which is incremented by one for each specimen, and resets to zero at the start of each year. The resultant CaseID is globally unique among all specimens received by the laboratory.

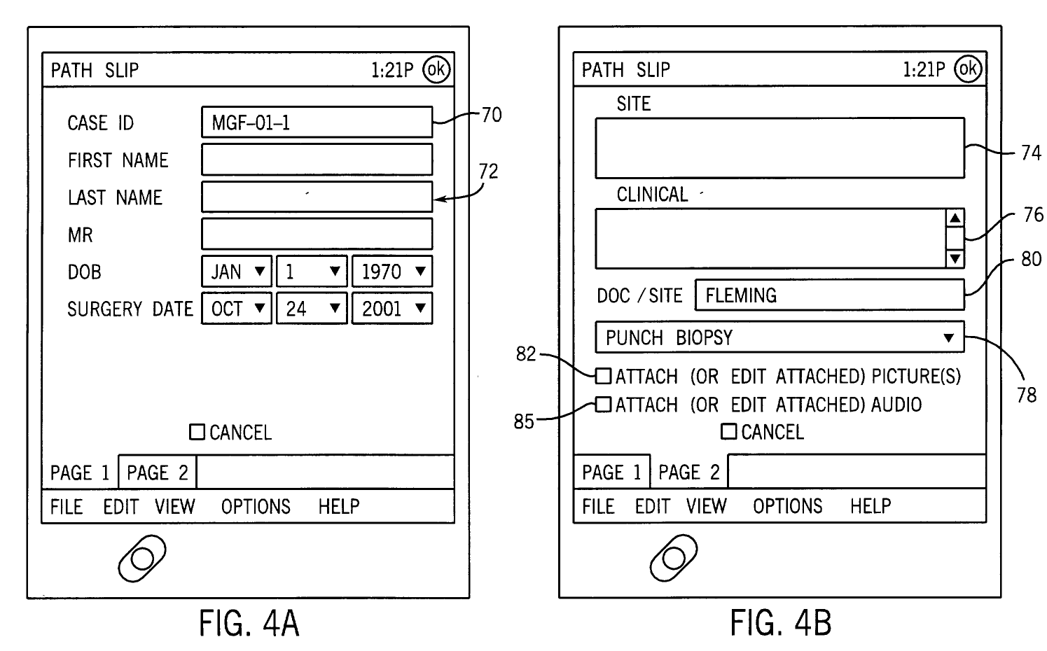

Referring now to FIGS. 4A and 4B, the submission slip comprises two pages containing textual data fields. The first page contains fields for patient identifying data 72, including patient's name, medical record number, and date of birth. These data are entered by a user when the slip is “new”, but are copied from an existing report when the slip is “cloned.” The second page (FIG. 4B) contains fields for medical information such as surgical site 74, clinical history 76, procedure type 78, and a doc/site field 80 that contains textual information used to identify the clinician and/or clinic from which the slip is submitted. Additional data, such as a slide number and the name of a slide preparer, can also be transmitted when slides, rather than tissue or other specimens, are submitted as samples. Additionally, the second page of the slip includes check boxes 82 and 85 for selecting functions to attach multimedia data, as described below.

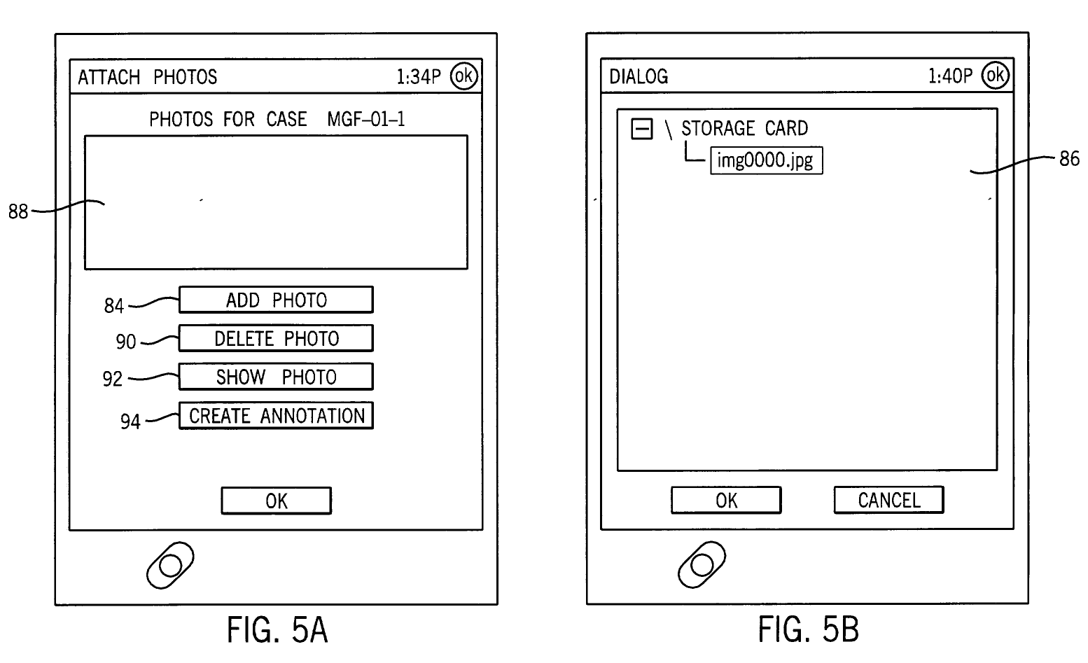

As the submission slip data are entered, the user can also elect to attach digital images to the submission slip by checking the “Attach pictures” box 82 on the second page of the slip, thereby activating an “Attach photos” dialog shown in FIG. 5A. To attach photos, the user places a memory card containing digital images in the card reader 32 of the clinical computing device 10 (FIG. 2), and presses the “Add Photo” button 84 to display a tree-structured listing 86 (FIG. 5B) of all directories on the memory card that contain digital images. Images are attached by clicking on the selected image, whereby the image is copied from the memory card to the memory 24 of the clinical computing device 10 and given a file name, of the form CaseID-nn, where nn is a number starting at zero and incremented for each image attached to the individual slip. The image name is stored in the database 35 of the clinical computing device 10, along with the textual data belonging to the submission slip, and is added to a list 88 in the “Attach Photos” dialog.

Referring again to FIG. 5A, images which are attached to a laboratory submission slip as described above can be deleted, displayed, or annotated through the use of the “Delete Photo” 90, “Show Photo” 92, and “Create Annotation” functions, respectively 94. To activate any of these functions, the image is selected by single-clicking on the file name, and then pressing the button corresponding to the desired function. The “Show Photo” function 92 starts an image viewer, which allows the image to be displayed at various sizes and also allows the image to be “panned” by grabbing the surface of the image and pushing it in the desired direction with the stylus. The “Create Annotation” function 94 allows the user to annotate the image using three modes of operation: “Move”, “Draw”, and “Text”. “Move” allows the user to view, re-size, and pan the image, as described above. “Draw” mode allows freehand drawing on the image using a stylus, while “Text” allows entry of a short textual label. After annotation, the annotated version of the image appears in the “Attach Photos” list along with the original, unedited version. Both are uploaded to the central laboratory computer 12, as described below. Upon completion of the annotation dialog, the image list is redisplayed allowing additional images to be added. If additional images are to be added, the program loops back to add or edit the next selected image.

Although the Attach Photo function has been shown and described in conjunction with physical movement of a memory card from a digital camera, other types of image transfer processes could also be used. For example, it would also be possible to effect this transfer using short range wireless networking technologies such as Bluetooth, or similar wireless technologies. Furthermore, although the attached images have been described as photographs, video images, and drawings, other graphical formats could also be used.

Referring again to FIG. 4B, digitized audio files can also be attached to submission slips by selecting the “Attach audio” box 85 on the second page of the slip. When “attach audio” is selected, an audio recording control is opened, allowing the user to enter audio information through the microphone 34 provided in the clinical computing device 10. Using this function, a clinician can record a voice message for the laboratory. Audio files are stored with the textual data in the same way as image files, described above.

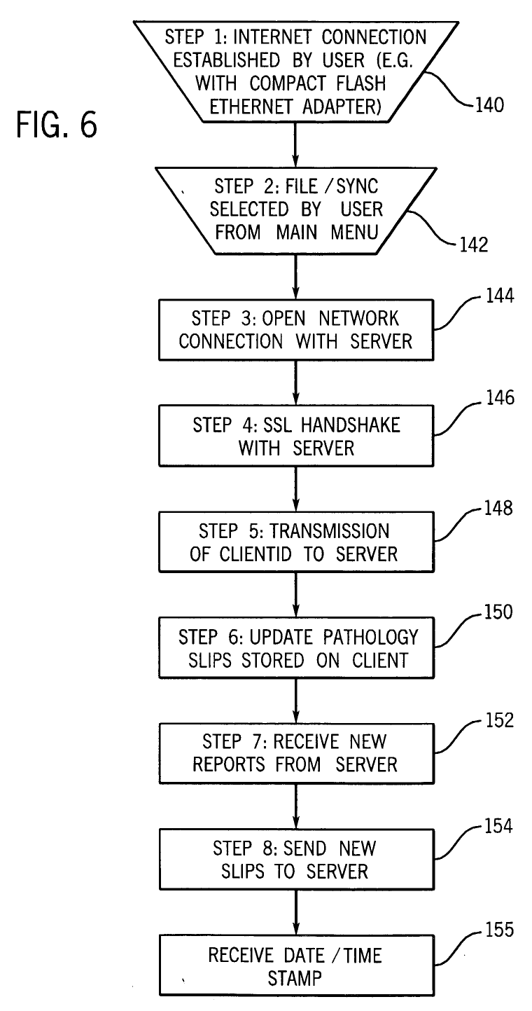

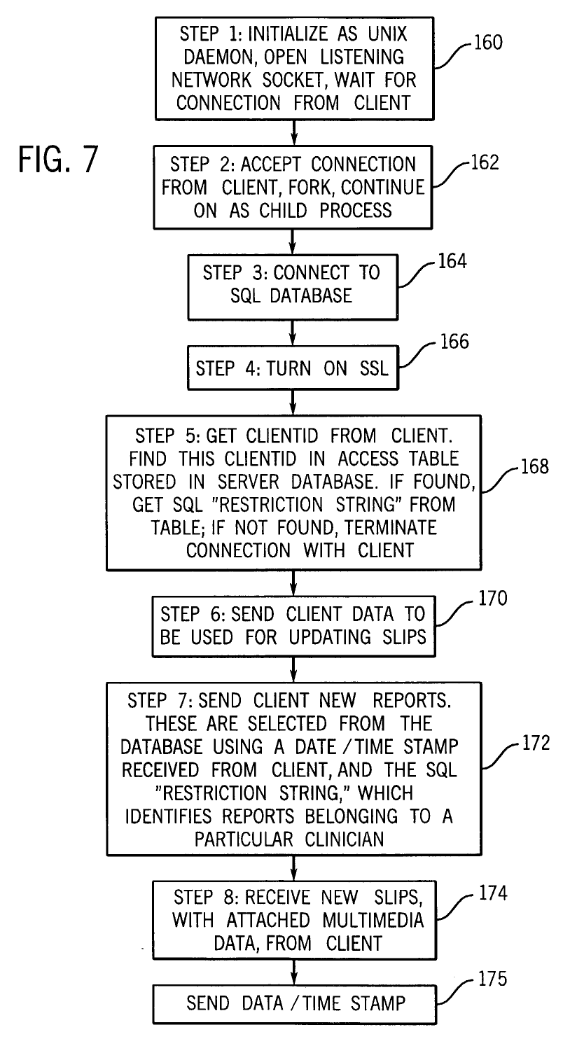

After the textual and multimedia data are entered into the submission slip, the slip is stored in the database 35 of the clinical computing device 10. A synchronization status category indicating that the slip is “not synced” is attached to the slip, and the “not synced” status is maintained until a synchronization process (FIGS. 6 and 7) is initiated by the user. The synchronization process transfers new submission slip data from the clinical computing device 10 to the laboratory computer 12, and also transfers updated submission slip data and laboratory reports from the laboratory computer 12 to the clinical computing device 10, as described below. During synchronization, the clinical computing device 10 maintains status data in the database 35, maintaining the synchronization status category of slips is either “synced” or “not synced”. Furthermore, reports uploaded from the laboratory computer 12 are maintained with a synchronization status category of “new” until read or otherwise recategorized, as described below.

Referring now to FIG. 6, a flow chart illustrating the synchronization process at the clinical computing device 10 is shown. To start the synchronization process, the clinical computing device 10 is initially connected to the Internet (step 140). This connection can be obtained by placing the clinical computing device 10 in a cradle connected to a PC which is itself connected to the Internet; via a compact flash or PCMCIA modem and dial-up Internet connection; or via a wired or wireless (802.11) compact flash or PCMCIA Ethernet adapter and broadband connection (such as cable modem, DSL, etc.).

Referring now also to FIG. 3A, after the connection is established, the user selects the File/Sync function 68 from the main menu 40 (step 142), and the clinical computing device 10 attempts to establish a link with the laboratory computer 12 by sending a message through the Internet link to the laboratory computer 12 indicating that a synchronization session is desired (step 144). Referring now also to FIG. 7, illustrating the synchronization process at the laboratory computer 12, the laboratory computer 12 listens for network connections at a specific port (step 160) and, when a connection is made, starts a separate (child) process for communicating with the clinical computing device 10 transmitting the synchronization message (step 162) and further provides a connection to its internal database 16 (step 164), while continuing to listen for additional connections. An encrypted communications link is established between the clinical communications device 10 and computer 12 using secure socket layer (SSL) communications (step 166, FIG. 7; step 146 FIG. 6), which are initiated using an SSL handshake method known to those of skill in the art. Berkeley sockets, secured by the Secure Socket Layer protocol, are preferably used for network communication by both clinical computing device 10 and laboratory computer 12.

After the encrypted communications link is established, the clinical computing device 10 transmits its ClientID string to the computer 12 (step 148, FIG. 6) which compares the ClientID against a list of authorized users (step 168, FIG. 7). If the computer 12 cannot identify the contacting device, the connection is dropped and the process terminated. If the device 10 can be authenticated, the synchronization process is allowed to continue. As noted above the synchronization process includes uploading new slips having a status of “not synced” from the clinical computing device 10 to the laboratory computer 12 (step 154, FIG. 6; step 174, FIG. 7), updating slips having a “synced” status maintained at the clinical computing device 10 with data from the laboratory computer 12 (step 150, FIG. 6; step 174, FIG. 7), and downloading laboratory reports from the laboratory computer 12 to the clinical computing device 10 (step 152, FIG. 6; step 172, FIG. 7) where they are assigned a synchronization status of “new”. During the synchronization process, the ClientID is used by the laboratory computer 12 to filter data transmitted to the client device 10. At the completion of the synchronization process a date/time stamp is transmitted to the clinical computing device 10 from the laboratory computer 12 (step 175, FIG. 7; step 155, FIG. 6), where it is stored for use during the next synchronization session (see paragraph 0053, below).

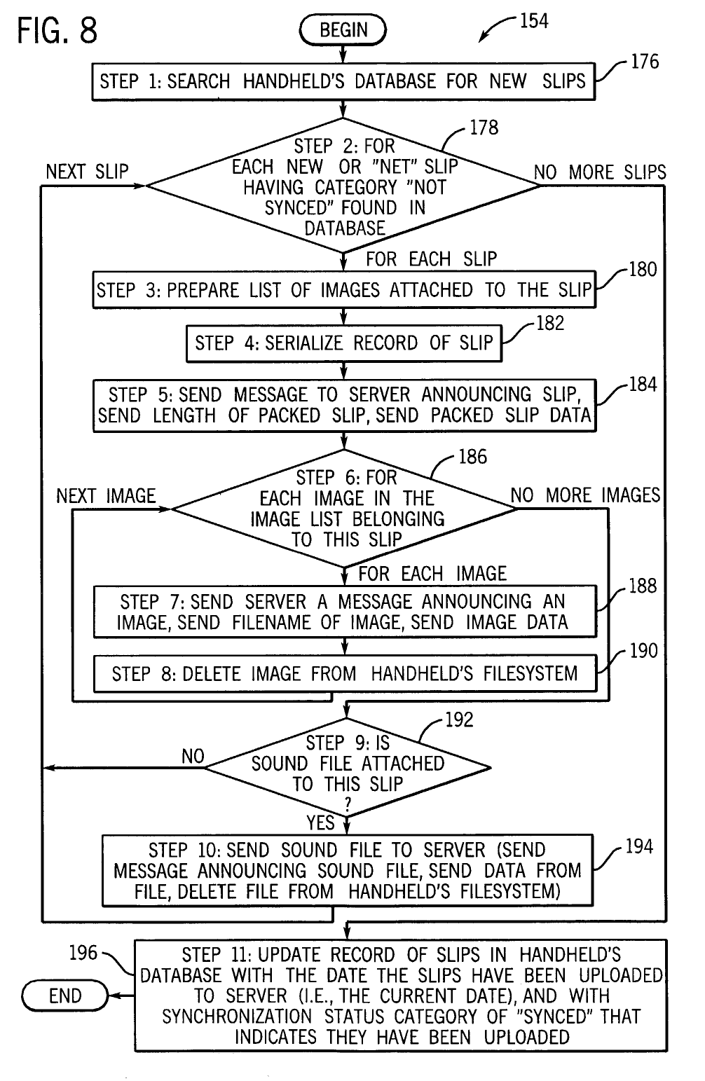

Referring now to FIG. 8, to transmit new laboratory slips to the computer 12, the device 10 initially searches its internal database 35 to identify laboratory slips which are categorized as “not synced” (step 176). For each new slip, the device 10 prepares a list of images attached to the slip (step 180). The device then serializes the data in the slip (step 180), and transmits a message to the laboratory computer 12 indicating that a slip is about to be transmitted, and indicating the length of the packed slip (step 188). The packed data are transmitted after the message. Next, each image in the image list is transmitted to the laboratory computer 12 as a byte stream following a message announcing that an image is being transmitted and providing the filename of the image (step 188). To save memory storage in the clinical device 10, the images are deleted from the memory 24 (FIG. 2) after transmission (step 190). After all of the images associated with the slip are transmitted, the audio file is transmitted in a similar manner (steps 192-193). After the slip's data are transmitted, a time stamp comprising the message “Synced on xxxx-xx-xx” is attached to the slip and stored with the slip in the database 35 of the clinical computing device 10 (step 196), and the slip is re-categorized with a synchronization status category of“synced”.

The data uploaded from the submission slip are stored in a table in the database 16 of the laboratory computer 12. Any multimedia data that may have accompanied the slip (images and audio) are stored as ordinary files. The names of these files are maintained in the database 16 of the laboratory computer 12.

Typically specimens are sent to the laboratory by the clinician either prior to or immediately after synchronization. These specimens are marked with the CaseID to allow the laboratory to match submission slips and specimens. When a specimen arrives, the CaseID number is entered into the laboratory computer 12 to retrieve the associated submission slip, which is displayed as part of a form for constructing a laboratory report. Most of the case data required for the laboratory report form is automatically filled in with data uploaded from the clinical computing device 10. The current date as generated by the computer 12 is stored in an accession date field and an accession number generated by the laboratory computer 12 is associated with the slip and specimen.

Data required for laboratory use can be entered manually, typically by clerical personnel, at this time. For example, clinical personnel associated with the case can be identified using physician and practice site codes employed by the laboratory. Similarly, a gross description of the specimen can be recorded. These fields can be entered as free text, or via a semiautomated menu/template system.

After the specimen is received and appropriate identifying data are entered, the specimen is provided to laboratory personnel for analysis. The laboratory personnel review the textual description and multimedia data which have been uploaded with the submission slip along with the submitted specimen. To access the multimedia date (images and audio), the laboratory personnel can use a browser connected to the laboratory's website via a network (typically an intranet). Preferably, for each piece of multimedia data that is attached to a slip or report, an icon providing a link to the multimedia data appears on the bottom of the webpage representing that slip or report. For images, the icon can be a thumbnail view of the image itself. For audio files the icon is a graphic which, when clicked, transfers the file to the browser and causes the browser to launch an application registered to handle audio files.

Alternatively, the multimedia data can be accessed with a more specialized program that runs on a networked computer 18 and communicates with the laboratory computer 12. When laboratory personnel call up a laboratory report form, the multimedia data are transferred to the computer 18, which displays the attached images and plays the attached audio using the specialized program. This program can also be used to attached new multimedia data, such as images recorded with a digital microscope camera.

After analysis of the submitted data and specimen, the laboratory personnel record the results by entering data into the laboratory computer 12, typically through a connection from a networked laboratory computer 18. The results include textual data such as a pathologic diagnosis and microscopic description, and can also include multimedia data such as digitized histologic images. In some applications, the histologic image can be annotated to provide additional information to the clinician, although this function may be limited by system requirements both at the laboratory computer 12 and clinical computing device 10.

After the report is complete, the laboratory personnel finalize or “sign-out” the case to change the status of the laboratory report in the database 12 of the laboratory computer 12. Upon sign-out, the laboratory computer 12 writes the system (current) date/time to the report as the sign-out date/time, and makes the report available for download to the clinical computing device 10 at the next sync session.

If the case cannot be completed within the usual time frame, the pathologist can record an explanation of the delay for transmittal to the clinical computing device 10. This process can be accomplished using two menus, the first containing reasons for the delay and the second containing expected completion dates. The first menu includes items such as: “Second opinion required” or “Outside consultant's opinion required”, while the second menu includes a selection of days in the future. The two menu selections are used to generate a message of the form: “This case was held for (reason selected from first menu). The expected completion date is (date selected from second menu)”. This message will be downloaded to the clinical computing device 10 at the next sync session, as described below, and is used to update the submission slip stored at the clinical computing device 10. If a case is delayed repeatedly, the explanations are cumulative.

Referring again to FIGS. 6 and 7, while the specimen is being processed at the laboratory, the clinician obtains updated status information by entering a synchronization process in which the operator establishes an Internet connection (step 140) and activates the File/Sync function (step 142) from the main menu of the clinical computing device 10 in order to update the data stored in the submission slip. In particular, data such as the gross description and estimated completion date for the procedure are downloaded to the clinical computing device 10. As noted above, during each synchronization session, new slips are uploaded to the laboratory computer 12, while updated slip data and reports are downloaded to the clinical computing device 10.

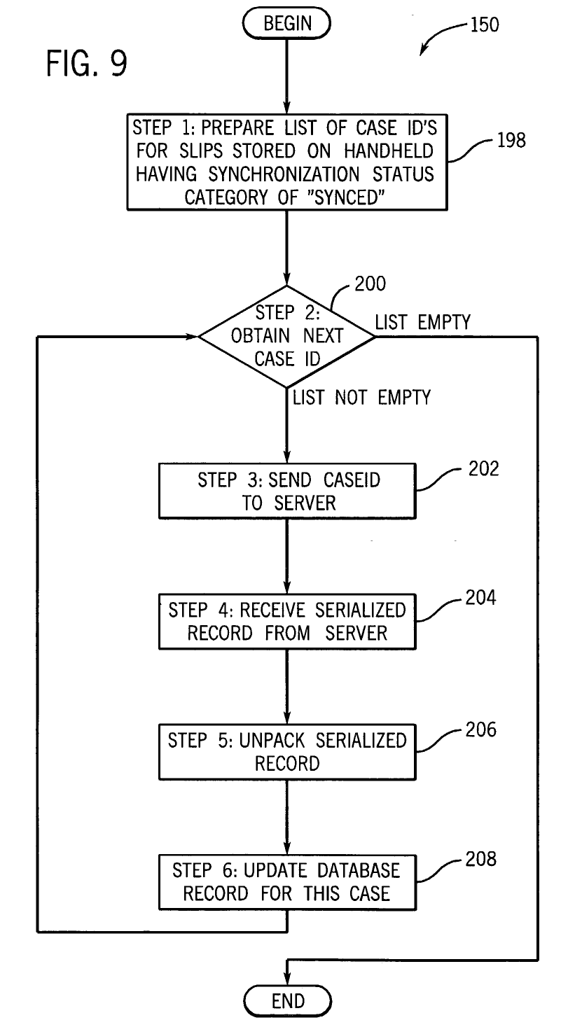

Referring now to FIG. 9, to update the slip data, the clinical computing device 10 initially prepares a list of all of its stored slips having a synchronization status of “synced”. These are previously uploaded slips, and are identified by CaseID (steps 198, 200). For each such slip, the clinical computing device 10 sends the laboratory computer 12 a messagegram indicating that it would like to update a slip, and then sends the CaseID (step 200). Upon receipt of this message, the computer 12 searches the database 16 for slips which are identified by that CaseID. When it finds the slip, it converts the slip to a packed, serialized format, and then sends the clinical computing device 10, first the length of the packed slip (in a messagegram), and then the packed slip itself. The clinical computing device 10 receives the serialized slip (step 206), unpacks the slip (step 204), and then updates the slip in its database using this information (step 208). If the slip is identified by the CaseID in the clinical computing device 10, the accession number provided by the laboratory replaces the CaseID. The laboratory computer 12 maintains both the CaseID and the accession number for each slip and searches for both numbers during subsequent synchronization sessions, to find new data both for slips that have not previously been updated and for slips that have been.

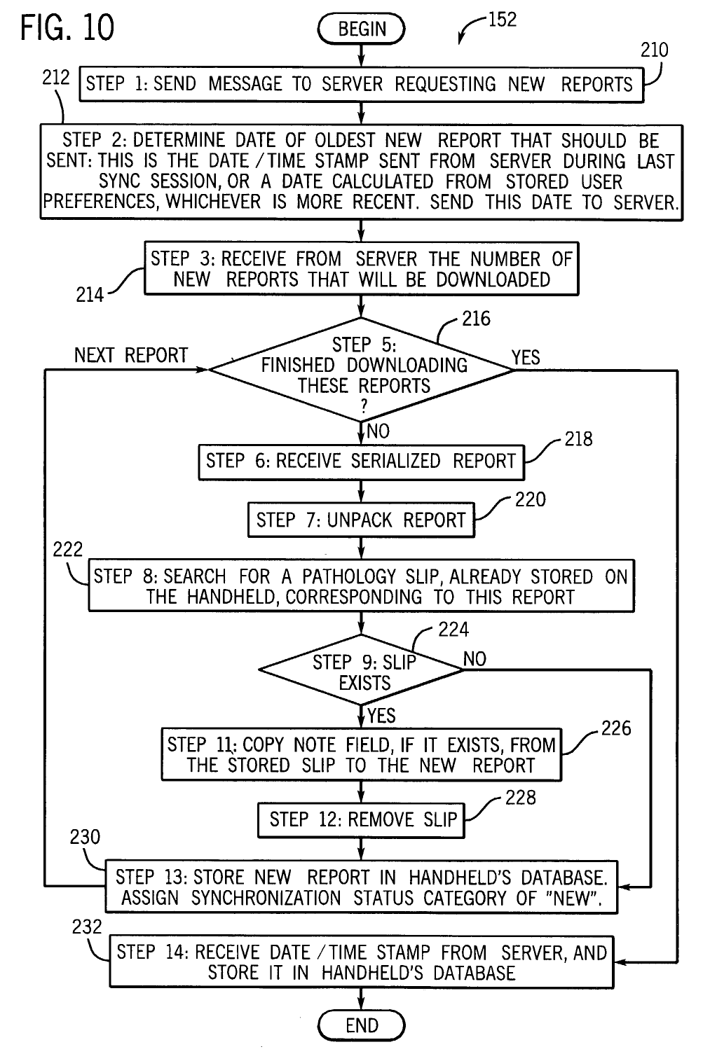

Referring again to FIGS. 6 and 7, at the first synchronization session after the case is finalized and signed out by the laboratory personnel, the completed report is downloaded to the clinical computing device 10 as data is synchronized between the clinical computing device and the laboratory computer 12. To download new reports from the laboratory computer 12 to the clinical computing device 10, the clinical computing device 10 is connected to the Internet, and the File|Sync function is activated by the user (steps 140 and 142) to begin a synchronization process that will upload slips, update slips, and download reports. Referring now to FIG. 10, once the Internet link is established the computer 12 sends a messagegram indicating that it would like to enter a syncing process to download reports, as described above (step 210). The clinical computing device 10 determines a date/time cutoff for comparison to the sign-out time of a report to determine whether the report should be downloaded. Typically this is the date/time stamp stored in the clinical computing device 10 during the last synchronization session. The selected cutoff date/time is transmitted to the laboratory computer 12 (step 212). Alternatively, the user may select an appropriate date/time at the Option|Preference menu described below.

The laboratory computer 12 searches its database for all reports finalized since the date/time received from the clinical computing device 10, and sends the number of reports to the clinical computing device 10 (step 214). For each such report, the laboratory computer 12 packs the report and sends the clinical computing device 10, first the length of the report (in a messagegram), and then the packed report. The clinical computing device 10 receives the serialized report and unpacks the report (steps 218 and 220). The clinical computing device 10 then searches for a stored slip having a CaseID or accession number corresponding to this report (step 222); if it finds one, it copies the note field from the slip to the report (step 226), deletes the submission slip (step 228), and saves the report (step 230), categorizing the report as “new”. If there is no slip corresponding to the report, the clinical computing device 10 just saves the report (step 230). Multimedia data are not downloaded, but the names of the files containing these data are, thereby allowing the clinical computing device 10 to access these images through an active Internet connection as described below.

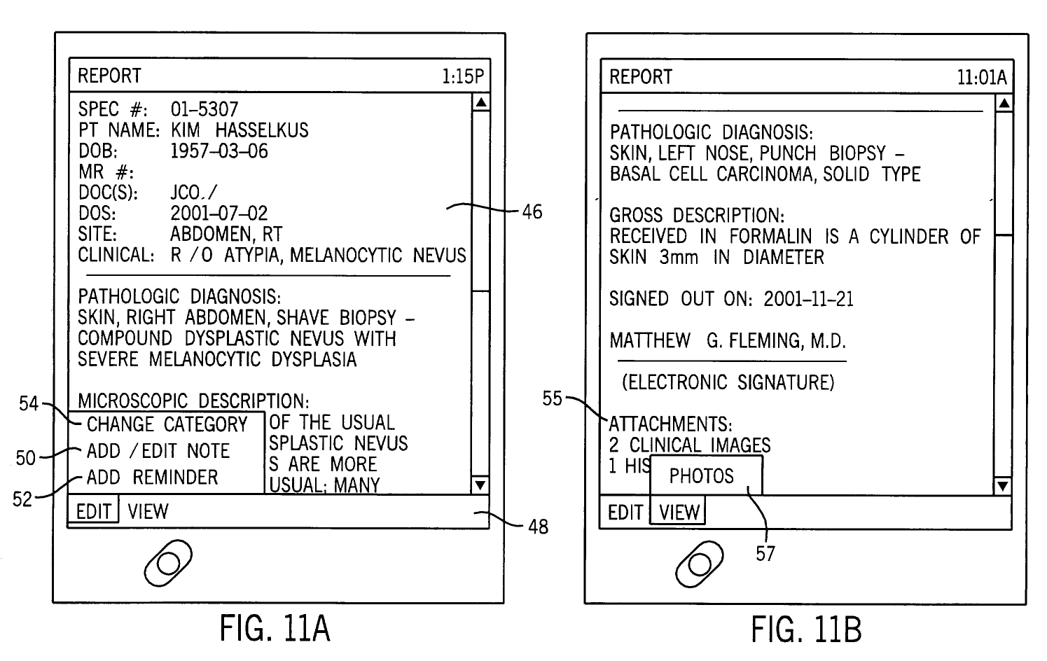

Referring again to FIGS. 3A-3D, on activation, a report list 42 of all reports received from the laboratory computer 12 and stored on the clinical computing device 10 is provided in the display 20 of the clinical computing device 10, along with a menu 40 for selecting various editing and file functions, described below. Double-clicking on any report contained in the main list displays the report, using the Report dialog of FIG. 11. Referring now to FIGS. 11A and B, in the Report dialog, textual data 46 is displayed along with a Report dialog menu 48. The presence of a note or multimedia data attached to the report is indicated by the the word “Attachments” 55 which appears after the text 46 of the report. If a note has been attached, the line “Note” is appended; if there are clinical images, the line “X clinical images” is displayed, where X is the number of attached clinical images; and if there are histologic images, the line “X histologic images” is displayed, where X is the number of histologic images.

FIG. 11A shows the menu functions available to the user while reading a report in the Report dialog. Tapping “Add|Edit Note” 50 activates a dialog for entry or editing of a note associated with the report. Tapping “Change category” 54 activates a dialog which allows the category of the report, as described below, to be changed. Tapping “Add Reminder” 56 activates a dialog which is used to attach reminders consisting of a (date, specimen number) pair to the report. When “File|Check reminders” 58 (FIG. 3A) is selected from the main menubar, a dialog is displayed for each reminder whose date is equal to or prior to the current date.

If images are attached, they can be listed by selecting the “View|Photos” menu item 57, which opens a dialog in which the filename of each attached image is listed, followed by the word “(clinical)” if it is a clinical image, or the word “(histologic)” if it is a histologic image.

As noted above, to save memory resources, the images are not routinely downloaded to the clinical computing device 10. Images, therefore, are accessed at the clinical computing device 10 through an active Internet or other networked communications connection to the laboratory computer 12. If such a connection exists, double-clicking on the name of an image initiates a process which obtains the image from the laboratory computer 12 and displays it on the clinical computing device 10. Because this process occurs in a separate thread, the user can proceed with another task while the download occurs; this task will be interrupted automatically by the image viewer once the image has been downloaded. Furthermore, image requests are queued: any number of images can be selected from the list, and they will then be downloaded sequentially, with the image viewer popping up for each one once it has been downloaded. The network connection to the laboratory computer 12 is closed automatically once the last of the requested images has been downloaded. Although images are not routinely downloaded, if sufficient memory is available images can be routinely downloaded to, and permanently stored on, the clinical computing device 10. Although the user typically accesses the multimedia data through the clinical computing device 10, the multimedia data can also be accessed through the laboratory's website using a browser.

Referring now to FIG. 3C, the type of reports listed in the report list 42 and their order can be modified via the functions contained in the View 61 menu on the main menubar. The “sort” part of this menu 56 determines whether the reports are placed in the list in alphabetical order, according to the last and first names of the patient, or in reverse chronological order, according to the surgery date (the date when the specimen was obtained). The “show” part of this menu 58 determines whether all reports or specific categories of reports are displayed.

Four categories of reports exist: “New”, “Old”, “Marked”, and “Remindered”. Reports newly downloaded to the clinical computing device 10 are automatically placed in the New category, and new reports are reclassified as Old either individually by using the “Edit|Change category” function 54 (FIG. 11A) from the Report menu or all at once, by using the “Edit|Change all new to old” function on the Edit function of the menubar 40 belonging to the main list (FIG. 3B). Typically, a user selects “View|New Reports” from the main menu 40 to generate a list of new reports, and then “Edit|Change category” 54 from the Report Dialog menu (FIG. 11A) to reclassify each report as Old, as it is read.

A report is placed in the Remindered category automatically after it has been displayed using the check reminder function which displays reports having a reminder with a date equal to or prior to the current date. The Marked category is intended as a kind of “to-do” list for the clinical computing device 10. A report can be placed in this category only by activation of the “Edit|Change category” function 54 (FIG. 11A), and is typically used with the “Edit|Add/Edit note” function 50 to identify and annotate reports which require some action.

The last item in the View menu 61, Filter 70, activates a Filter dialog which “filters” reports in the main list, so that the list displays only those reports belonging to patients whose last name begins with an arbitrary sequence of characters, and/or whose first name begins with an arbitrary sequence of characters, and/or whose surgery date is later than a specified date. Other methods for filtering the data will be apparent.

The submission slips stored on the clinical computing device 10 can be reviewed by selecting “View|Slips” 63 on the view 61 menu of the main menubar 40 of FIG. 6. A slip which has not yet been uploaded to the laboratory computer 12 will appear with the message “Not synced” as described above. Such a slip can be deleted or edited. Once the slip has been uploaded, it will appear with the message “Synced on xxxx-xx-xx”, as described above where “xxxx-xx-xx” is a date. As noted above, after the slip is synced it can no longer be edited or deleted. At any time a note can be attached to a slip. Attached notes are transferred to the downloaded report when the case is finalized by the laboratory.

Referring now to FIG. 3D various options can be set using the dialog opened by “Options|Preferences” 62 including a “Doc/Site default” field, and ClientID, as described above. As described above, the user can select a date/time stamp to be used as a cutoff date for downloading finalized reports. The cutoff date/time is used with the date/time stamp in determining which reports are to be downloaded from the laboratory computer 12 during the synchronization process.

Although the present invention is useful in providing laboratory submission slips for a variety of different types of medical specimens, it is particularly useful in applications in which visual examination is important, such as dermatopathology. In dermatopathology applications, the ability to transmit multimedia data including graphic images of tissue and lesions provides a significant advantage to the laboratory and clinical personnel involved in an analysis or diagnosis, particularly providing the laboratory with significantly better data than a sample alone, and allowing the clinician, by reference to image data, to quickly pinpoint the location of a biopsy. Additionally, the use of graphic tools in conjunction with photographic or image data allows the clinicians and laboratory personnel to highlight specific areas of interest, thereby providing faster, more efficient, and more accurate communications. Furthermore, the use of audio files allows the clinician to efficiently provide detailed clinical information, which again, is very important in dermatopathology applications.

It should be understood that the methods and apparatuses described above are only exemplary and do not limit the scope of the invention, and that various modifications could be made by those skilled in the art that would fall under the scope of the invention. For example, although specific types of database structures have been described, it will be apparent that other types of database structures can be used. Furthermore, various types of device identification schemes and encryption methods will be apparent to those of skill in the art. Additionally, although specific types of communications networks have been shown and described, any number of communications networks could be applied in the present application. To apprise the public of the scope of this invention, the following claims are made:

1. A method for communicating laboratory test data between a laboratory and a clinic, the method comprising:
(a) storing patient data including at least one of a textual and a multimedia description of a medical condition in an electronic laboratory submission slip on a clinical computing device;
(b) transmitting the laboratory submission slip to a laboratory computer where it is retrievable and modifiable by laboratory personnel; and
(c) periodically synchronizing data between the laboratory computer and the clinical computer to update the data in the laboratory submission slip, the updated information including status information for advising the clinician of the status of laboratory analysis.

2. The method as defined in claim 1, further comprising the step of transmitting a laboratory report including the results of an analysis of a specimen from the laboratory computer to the clinical computing device.

3. The method as defined in claim 1, wherein the multimedia data includes photographic data.

4. The method as defined in claim 3, further comprising the step of annotating the photographic data.

5. The method as defined in claim 1, wherein the multimedia data includes digitized audio data.

6. The method as defined in claim 5, further comprising the step of storing a synchronization status category with each slip in the database.

7. The method as defined in claim 1, further comprising the step of storing local data including notes and reminders in the clinical computing device.

8. The method as defined in claim 1, further comprising the step of selecting a synchronization function at the clinical computing device to synchronize the data between the clinical computing device and the laboratory computer.

9. The method as defined in claim 1, further comprising the step of assigning a case identification number to the electronic submission slip, the case identification number uniquely identifying the electronic submission slip to the client computing device and the laboratory computer device.

10. A method for communicating data between a clinician and a laboratory, the method comprising:
(a) storing patient data including at lease one of a textual and a multimedia medical description in an electronic submission slip in a clinical computing device;
(b) selectively transmitting the submission slip to a laboratory computer;
(c) forwarding a clinical specimen identified by the case identification number to the laboratory;
(d) retrieving the submission slip from the laboratory computer and correlating the case identification number of the specimen with the submission slip;
(e) analyzing the clinical specimen and providing the results in a laboratory report stored in the laboratory computer; and
(f) selectively transmitting the laboratory report from the laboratory computer to the clinical computing device.

11. The method as defined in claim 10, further comprising the step of periodically synchronizing data between the clinical computing device and the laboratory computer to provide updated status information.

12. The method as defined in claim 10, further comprising the steps of assigning an alphanumeric identifier to the clinical computing device, and authenticating the identity of the clinical computing device at the laboratory computer prior to accepting a submission slip.

13. The method as defined in claim 12, wherein the identifier comprises a first string of characters identifying an owner of the clinical computing device, and a second string of pseudorandom alphanumeric characters.

14. The method as defined in claim 10, further comprising the steps of encrypting the submission slip and the results prior to transmission.

15. The method as defined in claim 11, further comprising the step of providing access to histologic images from the laboratory computer at the clinical computing device.

16. The method as defined in claim 11, further comprising the steps of identifying the submission slip and the specimen with a case identification number, and correlating the specimen with the submission slip in the laboratory computer with the case identification number.

17. The method as defined in claim 11, further comprising the step of storing local data related to the submission slip or the report at the clinical computing device.

18. A clinical computing device for communicating laboratory submission and analysis data between a clinician and a laboratory, the clinical computing device comprising:
a data input device for receiving textual and multimedia patient data from a user;
a memory storage device, electrically coupled to receive the data from the data input device and to store the patient data in an electronic laboratory submission slip;
a communications device electrically coupled to the memory to receive the electronic submission slip from the memory and to transmit the electronic submission slips to the laboratory computer, and to receive test analysis data from the laboratory computer and to transmit the report to the memory storage device; and
a display electrically connected to receive the electronic submission slip and the report from the memory and to display the electronic submission slip and the test results to the user.

19. The clinical computing device as defined in claim 18, wherein the device comprises at least one of a pocket personal computer or a personal digital assistant.

20. The clinical computing device as defined in claim 18, further comprising a memory card reader for reading image data.

21. The clinical computing device as defined in claim 18, further comprising a microphone for recording audio notes.

22. The clinical computing device as defined in claim 18, wherein the communications device is a TCP/IP network access card.

23. The clinical computing device as define in claim 18, wherein the memory stores local data, including at least one of a note or a reminder for a clinician.
